(19) United States
(12) Patent Application Publication
(10) Pub. No.: US 2016/0355113 A1
(43) Pub. Date: Dec. 8, 2016

(54) METHOD AND APPARATUS FOR CONTROLLING A CLIMATE-CONTROL APPARATUS FOR A SEAT

(71) Applicant: Dr. Ing. h.c. F. Porsche Aktiengesellschaft, Stuttgart (DE)

(72) Inventor: Broder Soennichsen, Remseck am Neckar (DE)

(21) Appl. No.: 15/171,004

(22) Filed: Jun. 2, 2016

(30) Foreign Application Priority Data
Jun. 3, 2015 (DE) 102015108805.3

(51) Int. Cl. B60N 2/56; B64D 11/06; A47C 7/74

(52) U.S. Cl. CPC B60N 2/5678; A47C 7/74; B64D 11/0626

(57) ABSTRACT

A method for controlling a climate-control apparatus for at least one seat includes using a user interface to jointly regulate both at least one selection of at least one subregion, of which the temperature can be controlled, of the at least one seat, and a level of a temperature-control capacity of the climate-control apparatus in the at least one subregion, which is selectable using the user interface, of the at least one seat.

### CROSS REFERENCE TO RELATED APPLICATIONS

Priority is claimed to German Patent Application No. DE 10 2015 108 805.3, filed on Jun. 3, 2015, the entire disclosure of which is hereby incorporated by reference herein.

### FIELD

The present invention relates to a method for controlling a climate-control apparatus for at least one seat and also to a climate-control system and to a user interface.

### BACKGROUND

In order to control the climate for a user sitting on a seat, climate-control apparatuses, such as heating elements and/or cooling elements for example, which control the climate of, that is to say heat or cool, a respective seat in accordance with an operating mode which can be selected are provided in seats, in particular in vehicles or aircraft.

DE 199 55 326 A1 discloses an operator control device for adjusting a seat, it being possible to adjust the seat in the longitudinal direction using said operator control device.

German laid-open specification DE 10 2011 106 359 A1 discloses a vehicle seat having a first seat heater in a backrest of the motor vehicle seat and a second seat heater in a seat part of the motor vehicle seat and having a setting device for the seat heater, wherein the first seat heater can be regulated by the setting device independently of the second seat heater.

A seat with heating submodules in the backrest and seat part, which heating submodules can be actuated with a predefinable heating capacity by means of a controller using a preselection switch, is disclosed in international publication WO 2014/128105 A1.

German laid-open specification DE 10 2011 110 579 A1 discloses a heating apparatus for a seat having a first heating element in a backrest of the seat and a second heating element in a seat surface of the seat, wherein the temperatures of the first and the second heating element can be changed independently of one another.

### SUMMARY

In an embodiment, the present invention provides a method for controlling a climate-control apparatus for at least one seat including using a user interface to jointly regulate both at least one selection of at least one subregion, of which the temperature can be controlled, of the at least one seat, and a level of a temperature-control capacity of the climate-control apparatus in the at least one subregion, which is selectable using the user interface, of the at least one seat.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a schematic illustration of one possible refinement of the presented user interface.

FIG. 2 shows a schematic illustration of one possible refinement of the presented climate-control system for a vehicle seat.

### DETAILED DESCRIPTION

In an embodiment, the present invention provides a method for controlling a climate-control apparatus of a seat, which method is more convenient and more efficient than existing methods.

In an embodiment, the present invention provides a method for controlling a climate-control apparatus for at least one seat, in which method a user interface is used to jointly select both a selection of at least one subregion, of which the temperature can be controlled, of the at least one seat and also a temperature-control capacity of the climate-control apparatus or a temperature, which can be set by the climate-control apparatus, in the at least one subregion of the at least one seat.

The presented method serves, in particular, to control or regulate a climate-control apparatus for at least one seat, in particular in a vehicle or aircraft, based on a user interface by means of which both a selection of at least one subregion, of which the temperature can be controlled, of the at least one seat and also a temperature-control capacity, that is to say an intensity of an output of heat or cold, are jointly regulated or selected by the climate-control apparatus or a temperature, which can be set by the climate-control apparatus, in the at least one subregion of the at least one seat. Accordingly, it is provided that a user of the climate-control apparatus and, respectively, of the seat provides or inputs both a command for selecting a respective subregion, of which the temperature can be controlled, of the seat and also a command for controlling or regulating the temperature-control capacity in the respective subregion, of which the temperature can be controlled, of the seat via the user interface, and the commands which are provided or input by the user are processed by, for example, a controller, in particular independently of one another.

It is provided that the climate-control apparatus can comprise an air-conditioning system and/or a heater or at least one cooling element and/or at least one heating element.

In the context of the present invention, a user interface is intended to be understood to mean a point of an apparatus with which a person can make contact with the apparatus in order to, for example, transmit inputs to the apparatus.

According to the presented method, it is provided, in particular, that at least one respective subregion, of which the temperature can be controlled, of at least one respective seat and also a corresponding temperature-control capacity, that is to say an output of a respective climate-control apparatus for heating and, respectively, cooling the subregion, of which the temperature can be controlled, of the respective seat, are jointly set, that is to say are set in one operator control step for example, by means of the user interface which is provided according to the invention. To this end, a respective user can actuate, for example, two sensors, which form part of the user interface, substantially at the same time by, for example, moving in a horizontal direction in conjunction with a tapping movement in the vertical direction.

In one possible refinement of the presented method, it is provided that the climate-control apparatus selected is at least one seat heater which can be actuated using the user interface in such a way that the seat heater, depending on an input, which is provided using the user interface, by a user, selectively heats at least one subregion, which is specified by the input by the user, of the at least one seat in a temperature range, which is likewise provided by the user by means of the user interface, that is to say with a selected temperature-control capacity.

The presented method is particularly suitable for controlling or regulating a seat heater of a seat which comprises a plurality of subregions, such as a seat surface part and a seat backrest part for example. According to the presented method, both different subregions, of which the temperature can be controlled, of the seat can be selected and respective specific temperature-control capacities, which can be applied, for the respective subregions of the seat can be regulated or controlled by means of only one user interface. Accordingly, it is provided that the user interface which is provided according to the invention can detect at least two input parameters, specifically temperature-control capacity or temperature which can be set in the respective subregion of the seat, and distribution, that is to say a selection of a respective subregion of which the temperature can be controlled, of the respective seat. To this end, the user interface which is provided according to the invention can comprise, in particular, two sensor systems using which a respective user can input information relating to a desired temperature-control capacity and relating to a respective desired subregion, of which the temperature can be controlled, of the seat or a respective subregion, which can be selected and of which the temperature can be controlled, of the seat or relating to a temperature which can be set, it then being possible for said information to be processed by the respective climate-control apparatus, such as a provided seat heater for example, and accordingly implemented.

In particular, it is provided that a respective intensity of heat or cold, that is to say a respective temperature-control capacity, is allocated to a respective subregion of a seat by a respective user by means of the user interface which is provided according to the invention. To this end, it is provided in a refinement of the presented method that the user interface comprises at least two sensors which detect and process respective inputs by a user, that is to say combine said inputs with one another or process said inputs independently of one another for example. Accordingly, it is possible, for example, to provide a pull/push switch for inputting information in respect of a respective subregion, of which the temperature can be controlled, of a respective seat and a momentary contact switch for inputting information in respect of a temperature-control capacity, which can be provided by the climate-control apparatus, for the subregions, of which the temperature can be controlled, of the seat. In order to combine the information relating to the temperature-control capacity with the information relating to the respective subregion of which the temperature can be controlled, it is possible, for example, for the pull/push switch to be moved to a position which is characteristic of a respective subregion of the seat and at the same time for the momentary contact switch to be pushed for as often and/or as long as desired in order to input the temperature-control capacity for the previously selected subregion of the seat.

The present invention further relates to a climate-control system for at least one seat, having a user interface and at least one climate-control apparatus, wherein the user interface comprises a controller which is designed to actuate the at least one climate-control apparatus, depending on at least one user input which can be detected using the user interface, in such a way that only the temperature of subregions, which are selected by the at least one user input, of the at least one seat is controlled in a respective temperature range which is dependent on the at least one user input.

The presented climate-control system serves, in particular, to carry out the presented method.

The present invention further relates to a user interface for controlling a climate-control apparatus for at least one seat which is designed to actuate a controller of a climate-control apparatus, which controller is designed to actuate the climate-control apparatus, depending on a user input which can be detected using the user interface, in such a way that only the temperature of subregions, which are selected by the at least one user input, of the at least one seat is controlled in a respective temperature range which is dependent on the at least one user input.

The presented user interface serves, in particular, to carry out the presented method and, respectively, to operate the presented climate-control system.

The presented user interface combines two inputs, which are independent of one another, to control or regulate distribution of heat or cold, that is to say one input for selecting at least one subregion, of which the temperature can be controlled, of a respective seat and one input for the temperature-control capacity with which the temperature of the at least one selected subregion of the respective seat can be controlled. This means that a respective user only needs to operate the presented user interface in order to set or to regulate both the distribution of the heat or cold and also the intensity of the heat or cold, that is to say the temperature-control capacity of the respective climate-control system.

In one possible refinement of the presented user interface, it is provided that the presented user interface comprises at least two sensors by means of which inputs which are made by the user in respect of the temperature-control capacity of the climate-control apparatus and the selection of at least one subregion, of which the temperature can be controlled, of a seat can be detected.

In order to detect two user inputs, in particular for selecting the at least one subregion, of which the temperature can be controlled, of the at least one seat and for setting the temperature-control capacity of the climate-control apparatus, it is provided in one refinement that the presented user interface comprises two independent sensors, such as, for example, a first sensor for detecting an axial movement and a second touch-sensitive sensor, such as a momentary-contact switch for example. The use of two independent sensors allows the user to use the first sensor to set a first input, that is to say the selection of a respective subregion, of which the temperature can be controlled, of the at least one seat for example, by means of a slide along a longitudinal axis for example and in a further step to set the temperature-control capacity of the climate-control device for setting a desired temperature in the selected subregion of the at least one seat by means of, for example, pushing a momentary-contact switch or a touchpad by means of the same user interface.

It goes without saying that any further refinement of a user interface, that is to say of a sensor for detecting a user input, for selecting a subregion, of which the temperature can be controlled, of a seat or for setting a temperature-control capacity, in particular in the form of a rotary switch or rotary pushbutton, is also feasible. In particular, it is provided that respective user inputs which are detected by the first and the second sensor are combined by, for example, a controller, so that, for example, a respective selected intensity is associated with a respective selected subregion.

In order to associate a respective user input which is made by means of the first sensor to a user input which is made by means of the second sensor, it is possible, for example, to prespecify a time range within which user inputs which are detected by the first sensor and the second sensor are jointly processed, that is to say allocated to one another.

In a further possible refinement of the presented user interface, it is provided that the user interface comprises at least one indicator unit which is designed to indicate a currently selected temperature range or a currently selected intensity and/or a currently selected subregion.

In order to provide a respective user with feedback about a current setting of the climate-control system, it is provided in one refinement that the user interface comprises at least one indicator unit, in particular a number of lighting bodies, such as LEDs for example, which light up or do not light up depending on a currently set intensity, that is to say a currently set temperature-control capacity of the climate-control system, and/or depending on a currently actuated subregion of the at least one seat.

In particular, it is provided that the indicator unit is arranged at a physical distance from a sensor system which is provided for detecting a user input, for example in a dashboard of a respective vehicle, or is integrated into an indicator unit which is arranged on the dashboard.

Further advantages and refinements of the invention can be gathered from the description and the accompanying drawings.

It goes without saying that the features mentioned above and those still to be explained in the text which follows can be used not only in the respectively indicated combination but also in other combinations or on their own, without departing from the scope of the present invention.

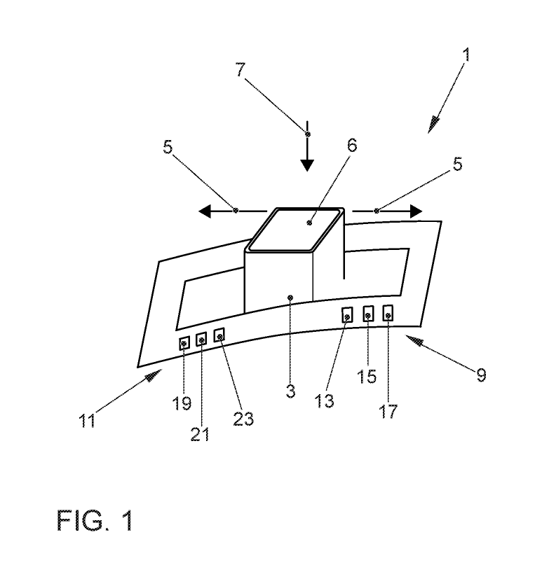

FIG. 1 shows a user interface 1 which is arranged, for example, on an armrest of a respective seat or on a center console of a respective vehicle.

The user interface 1 comprises an operator control button 3. The operator control button 3 can be moved in the horizontal direction, as indicated by arrows 5. When the operator control button 3 is moved, a first, for example mechanical, sensor of the user interface 1 is activated, said sensor detecting a direction and a distance covered during the movement operation or a duration of the movement operation of the operator control button 3 and transmitting corresponding data to a controller, not illustrated here.

The operator control button 3 further comprises a second sensor 6, for example a pushbutton, by means of which a further input of the user can be detected. The user can choose between different temperature-control capacity stages of a heater of a seat, which is connected to the user interface, for example by tapping on the second sensor 6, as indicated by arrow 7. To this end, the second sensor 6 detects a duration and/or a number of respective tapping movements by the user and transmits corresponding data to the controller.

As soon as the controller has received the data from the first sensor and the second sensor 6, and the data no longer changes, for example within a prespecified time period, the controller generates a control signal and controls the heater, which is connected to the user interface 1, in accordance with the data which is provided by the first sensor and the second sensor 6.

In order to provide the user with feedback in respect of currently set parameters of the heater, the user interface 1 comprises indicator units 9 and 11. The indicator unit 9, which consists of three individual LEDs 13, 15 and 17, indicates a currently set intensity, while the indicator unit 11, which consists of three individual LEDs 19, 21 and 23, indicates currently selected subregions of the heater and, as a result of this, of a respective subregion of the seat which comprises the heater.

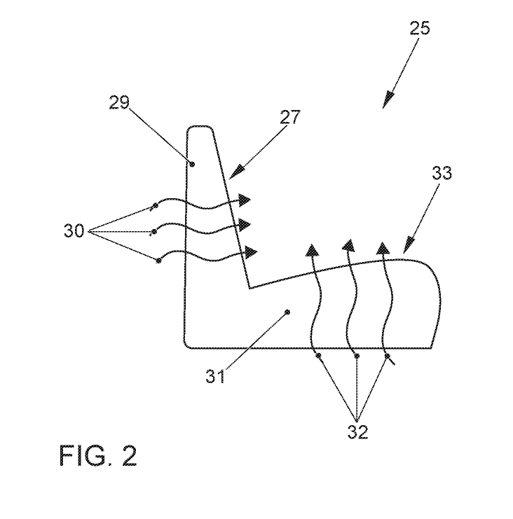

FIG. 2 shows a seat 25 having a seat heater which comprises a first subregion 27 in a first subregion of the seat, specifically in a seat backrest 29, as indicated by arrows 30, and a second subregion 31 in a second subregion of the seat, specifically in a seat surface 33 of the seat 25, as indicated by arrows 32.

The user interface 1 shown in FIG. 1 can be used to select between operation of the first subregion 27 and/or of the second subregion 31 of the seat heater. Furthermore, the intensity, that is to say the temperature-control capacity, of the first subregion 27 and of the second subregion 31 can be regulated by, for example, the operator control button 3 being deflected in a first direction and at the same time the second sensor 6 being tapped twice, so that the second subregion 31 is operated in a second heating stage.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1: A method for controlling a climate-control apparatus for at least one seat, the method comprising:
using a user interface to jointly regulate both:
at least one selection of at least one subregion, of which the temperature can be controlled, of the at least one seat, and
a level of a temperature-control capacity of the climate-control apparatus in the at least one subregion, which is selectable using the user interface, of the at least one seat.

2: The method as recited in claim 1, wherein the climate-control apparatus includes at least one seat heater that is actuatable using the user interface in such a way that the seat heater, depending on an input, which is provided using the user interface, by a user, selectively controls the temperature of at least one subregion, which is specified by the input by the user, of the at least one seat in a temperature range which is likewise provided by the user by means of the user interface.

3: A climate-control system for at least one seat, the climate control system comprising:
at least one climate-control apparatus; and
a user interface including a controller configured to actuate the at least one climate-control apparatus, depending on at least one user input that is detectable using the user interface, in such a way that the temperature of subregions, which are selected by the at least one user input, of the at least one seat is controlled in a respective temperature range which is dependent on the at least one user input.

4: The climate-control system as claimed in claim 3, wherein the at least one seat comprises subregions including at least a seat surface subregion and a seat backrest subregion, the temperature of which subregions is controllable in each case independently of one another using the at least one climate-control apparatus.

5: A user interface for controlling a climate-control apparatus for at least one seat operable to actuate a controller of the climate-control apparatus, which controller is configured to actuate the climate-control apparatus, depending on a user input that is detectable using the user interface, in such a way that the temperature of subregions, which are selected by the at least one user input, of the at least one seat is controlled in a respective temperature range which is dependent on the at least one user input.

6: The user interface as recited in claim 5, wherein the user interface comprises at least two sensors operable to provide inputs, which are made by the user, so as to select the temperature range and the at least one subregion of the at least one seat, of which subregion the temperature is controllable.

7: The user interface as recited in claim 6, wherein at least one of the at least two sensors is a sensor for identifying axial movement.

8: The user interface as recited in claim 6, wherein the at least one of the at least two sensors is a touch-sensitive sensor.

9: The user interface as recited in claim 5, wherein the user interface comprises at least one indicator unit configured to indicate at least one of a currently selected temperature range or a currently selected subregion of the at least one seat.
